(19) United States
(12) Patent Application Publication
(10) Pub. No.: US 2010/0000192 A1
(43) Pub. Date: Jan. 7, 2010

(54) Mower Mounted Trimmer

(76) Inventor: Joseph M. Robison, Carterville, MO (US)

Correspondence Address: HOVEY WILLIAMS LLP, 10801 Mastin Blvd., Suite 1000, Overland Park, KS, 66210, US

(21) Appl. No.: 12/166,948

(22) Filed: Jul. 2, 2008

(51) Int. Cl. A01D 43/16; A01D 43/00; A01D 34/66; A01D 34/84; A01D 75/18

(52) U.S. Cl. 56/10.2 R

(57) ABSTRACT

A mower and trimmer assembly is provided which permits normal mowing operations while also allowing the user to trim using an attached line-type trimmer. The assembly includes a mower and a separate trimmer. A coupling assembly interconnects the trimmer assembly and the power source of the mower. The coupling assembly includes a switch-controlled electromagnetic clutch for selectively creating a driving connection between power source and the cutting head of the trimmer assembly. The coupling assembly also includes a safety mechanism that prevents the trimmer from being powered during a mower operating condition.

### BACKGROUND

1. Field

The present invention relates generally to vegetation mowing and trimming devices. More particularly, an embodiment of the present invention concerns a multi-purpose mower that includes a trimmer selectively powered by the mower and a safety mechanism that prevents the trimmer from being powered during a mower operating condition.

2. Discussion of Prior Art

Mobile grass mowing equipment has long been available to homeowners and groundskeepers. Such equipment can be as simple as a common walk-behind gasoline-powered lawn mower, through riding mowers of various sizes, and up to large pull-behind mowers coupled to a tractor power take-off (PTO). Mobile line-trimming equipment has also been widely used and generally involves hand-carried units that include a lowermost rotatable trimming head equipped with one or more flexible cutting lines formed of monofilament or like synthetic resin material. Prior art trimmers further include an oblique handle that supports the trimming head and a gasoline or electric motor spaced from the trimming head at an opposite end of the handle. Power from the motor is conveyed through a drive line extending along the length of the handle. Mower/trimmer combinations, i.e., where a trimmer is drivingly attached to and thereby powered by a mower, are also known in the art.

Prior art trimmers are problematic and suffer from various undesirable limitations. For instance, independently powered prior art trimmers require a dedicated power source to be mounted on the trimmer handle, which makes the trimmer heavy to operate. Prior art mower/trimmer combinations are also problematic. For example, such combinations involve a restrictive driving connection between the trimmer and mower that greatly limits the operator's freedom of trimming movement. Prior art mower/trimmer combinations are also unsafe to use because an operator who uses a trimmer could potentially be inadvertently injured by the mower that powers the trimmer.

### SUMMARY

The present invention provides a multi-purpose lawn care machine that does not suffer from the problems and limitations of the prior art trimmers and mowers set forth above.

A first aspect of the present invention concerns a multi-purpose lawn care machine configured to mow and trim vegetation. The multi-purpose lawn care machine broadly includes a powered mower, a line trimmer, and a coupling assembly. The powered mower is operable to mow the vegetation and includes a wheeled mower body and an engine that powers a mower wheel to propel the mower body. The line trimmer is operable to trim the vegetation and includes a handle, a trimmer head rotatably mounted relative to the handle to cut the vegetation, and a rotatable drive shaft drivingly attached relative to the trimmer head. The coupling assembly includes an electromagnetic coupler and a safety switch assembly operably connected to the coupler. The electromagnetic coupler selectively drivingly interconnects the engine and the drive shaft to power the trimmer. The electromagnetic coupler is configured to shift between an engaged position to drivingly connect the drive shaft to the engine so that the trimmer is powered by the engine, and a disengaged position to drivingly disconnect the drive shaft from the engine so as to prevent the trimmer from being powered by the engine. The safety switch assembly includes a sensor operably connected to the powered mower to shift the safety switch assembly into and out of an off condition, with the safety switch assembly disengaging the coupler in the off condition. The sensor is operable to detect a mower operating condition associated with traveling movement of the powered mower. The sensor causes the safety switch assembly to be retained in the off condition in response to the operating condition to restrict the trimmer from being powered while traveling movement occurs.

A second aspect of the present invention concerns a trimmer kit for attachment to a powered mower, wherein the powered mower is operable to mow vegetation and includes a wheeled mower body and an engine that powers a mower wheel to propel the mower body, with the powered mower being shiftable into and out of a park condition associated with the powered mower being parked. The trimmer kit broadly includes a trimmer and a coupling assembly. The trimmer is operable to trim the vegetation and includes a handle, a trimmer head rotatably mounted relative to the handle to cut the vegetation, and a rotatable drive shaft drivingly attached relative to the trimmer head. The coupling assembly includes an electromagnetic coupler and a safety switch assembly operably connected to the coupler. The electromagnetic coupler is operable to selectively drivingly interconnect the engine and the drive shaft to power the trimmer. The electromagnetic coupler is configured to shift between an engaged position to drivingly connect the drive shaft to the engine so that the trimmer is powered by the engine, and a disengaged position to drivingly disconnect the drive shaft from the engine so as to prevent the trimmer from being powered by the engine. The safety switch assembly includes a sensor configured to be operably connected to the powered mower to shift the safety switch assembly into and out of an off condition, with the safety switch assembly disengaging the coupler in the off condition. The sensor is operable to detect a mower operating condition associated with traveling movement of the powered mower. The sensor causes the safety switch assembly to be retained in the off condition in response to the operating condition to restrict the trimmer from being powered while traveling movement occurs.

A third aspect of the present invention concerns a multi-purpose lawn care machine configured to mow and trim vegetation. The multi-purpose lawn care machine broadly includes a powered mower, a line trimmer, and a coupling assembly. The powered mower is operable to mow the vegetation and includes a wheeled mower body and an engine that powers a mower wheel to propel the mower body. The line trimmer is operable to trim the vegetation and includes a handle, a trimmer head rotatably mounted relative to the handle to cut the vegetation, and a rotatable drive shaft drivingly attached relative to the trimmer head. The coupling assembly includes an electromagnetic coupler and a safety switch assembly operably connected to the coupler. The electromagnetic coupler selectively drivingly interconnects the engine and the drive shaft to power the trimmer. The electromagnetic coupler is configured to shift between an engaged position to drivingly connect the drive shaft to the engine so that the trimmer is powered by the engine, and a disengaged position to drivingly disconnect the drive shaft from the engine so as to prevent the trimmer from being powered by the engine. The safety switch assembly includes a sensor operably connected to the powered mower to shift the safety switch assembly into and out of an off condition, with the safety switch assembly disengaging the coupler in the off condition. The sensor is operable to detect a mower operating condition associated with a mowing operation of the powered mower. The sensor causes the safety switch assembly to be retained in the off condition in response to the operating condition to restrict the trimmer from being powered while the mowing operation occurs.

A fourth aspect of the present invention concerns a trimmer kit for attachment to a powered mower, wherein the powered mower is operable to mow vegetation and includes a wheeled mower body and an engine that powers a mower wheel to propel the mower body. The trimmer kit broadly includes a trimmer and a coupling assembly. The trimmer is operable to trim the vegetation and includes a handle, a trimmer head rotatably mounted relative to the handle to cut the vegetation, and a rotatable drive shaft drivingly attached relative to the trimmer head. The coupling assembly includes an electromagnetic coupler and a safety switch assembly operably connected to the coupler. The electromagnetic coupler is operable to selectively drivingly interconnect the engine and the drive shaft to power the trimmer. The electromagnetic coupler is configured to shift between an engaged position to drivingly connect the drive shaft to the engine so that the trimmer is powered by the engine, and a disengaged position to drivingly disconnect the drive shaft from the engine so as to prevent the trimmer from being powered by the engine. The safety switch assembly includes a sensor configured to be operably connected to the powered mower to shift the safety switch assembly into and out of an off condition, with the safety switch assembly disengaging the coupler in the off condition. The sensor is operable to detect a mower operating condition associated with a mowing operation of the powered mower. The sensor causes the safety switch assembly to be retained in the off condition in response to the operating condition to restrict the trimmer from being powered while the mowing operation occurs.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a perspective view of a mower and trimmer assembly constructed in accordance with a preferred embodiment of the present invention, shown with the trimmer in a resting position;

FIG. 2 is a fragmentary perspective of the mower and trimmer assembly as shown in FIG. 1, showing a trimmer of the assembly in an operational position;

FIG. 3 is an enlarged, fragmentary, exploded view of the mower and trimmer assembly shown in FIGS. 1 and 2, showing a preferred coupling assembly that drivingly interconnects an engine of the mower with the trimmer; and

FIG. 4 is a fragmentary schematic view of the mower and trimmer assembly shown in FIGS. 1-3, showing the coupling assembly including a safety switch assembly with a proximity switch mounted adjacent to the transmission and a proximity switch mounted adjacent to a power take-off of the engine.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

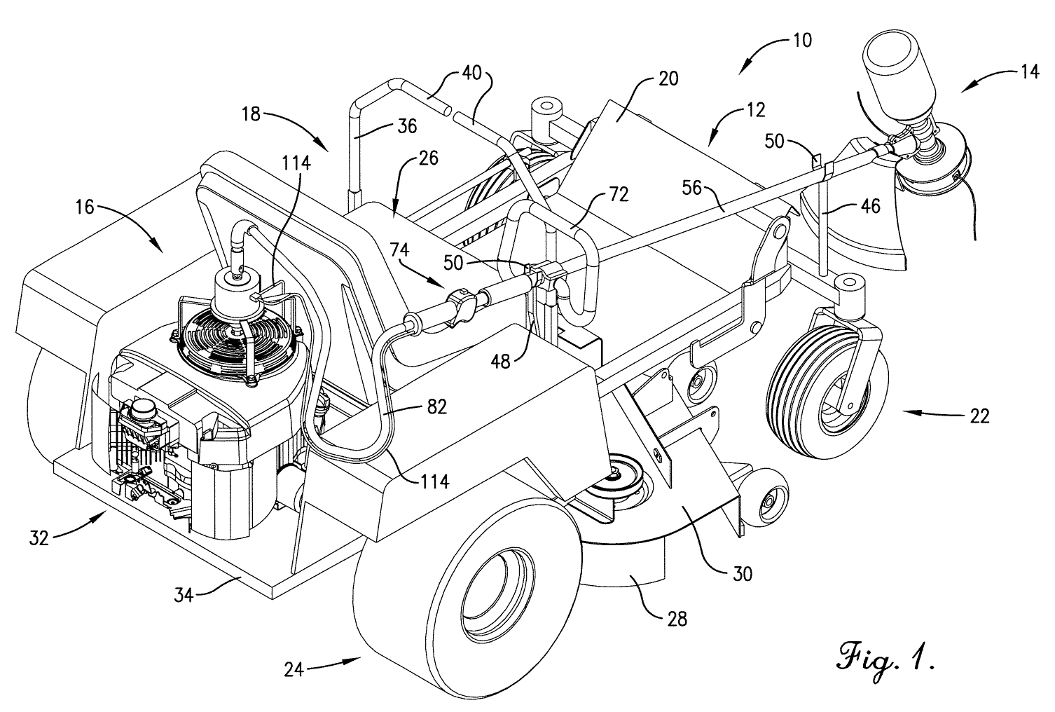

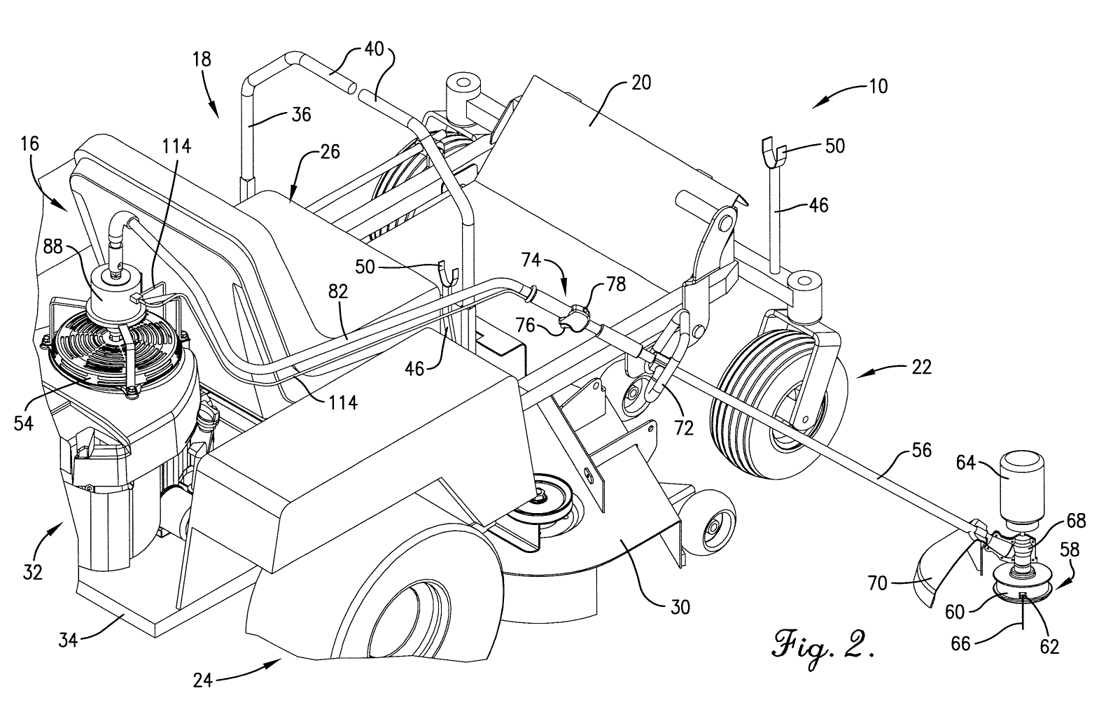

Turning now to the drawings, FIGS. 1 and 2 illustrate a multi-purpose mower 10 constructed in accordance with a preferred embodiment of the present invention. While the illustrated mower 10 is preferably used for mowing and trimming vegetation, the principles of the present invention are applicable where the mower 10 is used for other tasks that can be accomplished with a mobile utility vehicle and a tool that is powered by a power supply of the vehicle. The mower 10 broadly includes a conventional riding lawn mower 12, a trimmer 14, and a coupling assembly 16. As will be discussed in greater detail, the mower 10 provides the usual mowing capabilities of the mower 12, while also allowing an operator to use the attached trimmer 14 to trim in tight or inaccessible areas where the mower 12 cannot be used.

In more detail, the lawn mower 12 is itself conventional and includes a rolling mower body 18 including a mower chassis 20, fore and aft wheels 22,24 rotatably attached to the chassis 20, and operator seat 26 mounted on the chassis 20. The mower 12 further includes a mower deck 28 with a housing 30 shiftably mounted to the chassis 20 and rotatable blades (not shown) located within the housing 30. Yet further, the mower 12 preferably includes a gasoline powered engine 32 carried on a rearmost deck 34 of the mower body 18. But the principles of the present invention are also applicable where an alternative type of motive power is used, such as an electric motor or another type of internal combustion engine.

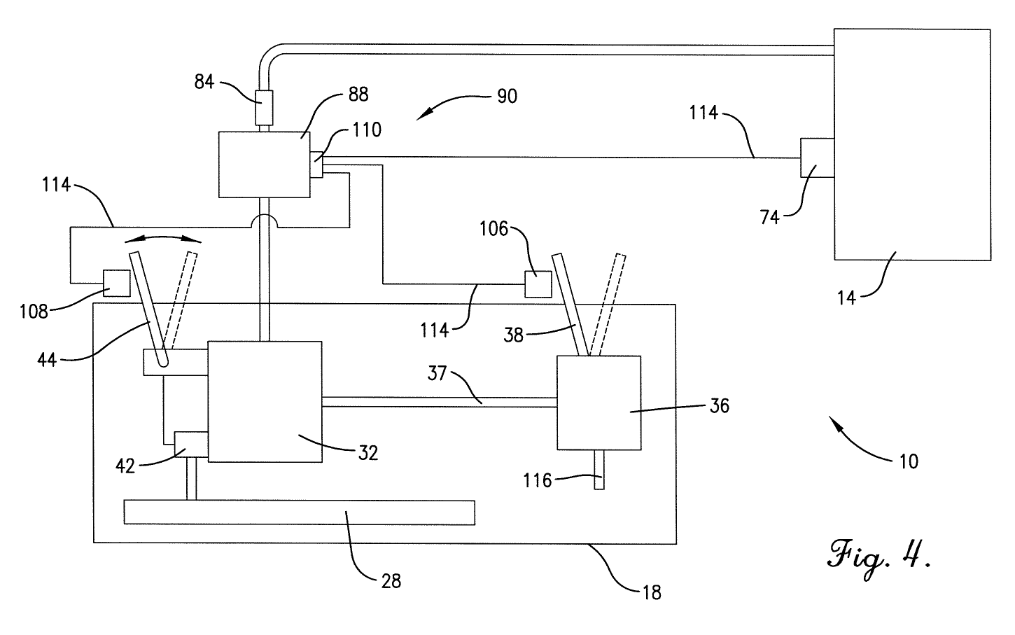

Turning to FIGS. 1, 2 and 4, the engine 32 is preferably drivingly coupled to the aft wheels 24 by a transmission 36 in the usual manner, with the engine 32 and transmission 36 being drivingly interconnected by a crankshaft 37. The transmission 36 includes a transmission park lever 38 shiftable between parked and drive positions that correspond with parked and drive conditions of the transmission 36 for selectively permitting power transfer to the wheels 24. The transmission 36 also includes wheel speed levers 40 that are operable to control direction and speed of respective ones of the aft wheels 24 when the lever 38 is engaged in the drive position. The engine 32 is also conventionally coupled with the mower deck 28 by a power take-off (PTO) 42 of the engine 32 (see FIG. 4) and by a belt (not shown) for powered rotation of the blades. The PTO 42 is shiftable between engaged and disengaged conditions by a PTO lever 44 that shifts between corresponding engaged and disengaged positions for selectively engaging the mower deck 28.

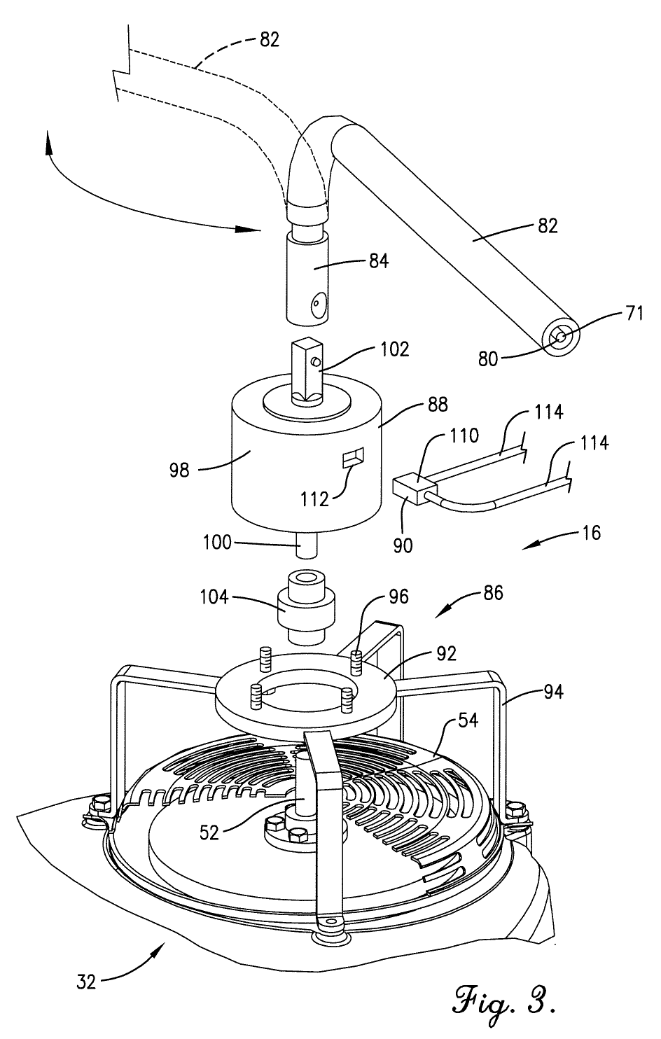

Turning to FIGS. 1-3, the mower body 16 further includes a pair of upright support arms 46 and 48, each with a generally U-shaped retainer 50 fixed to an uppermost stanchion. The engine 32 also includes a vertically extending, rotating shaft 52 which extends through an upper cover 54 (see FIG. 3), the use of which will be discussed further. While the illustrated mower 12 is preferred for providing a multi-purpose trimmer that can trim in tight areas, it is also within the ambit of the present invention where another type of powered vehicle is used in place of the mower 12.

The trimmer 14 includes an elongated, rigid, annular handle 56 and a lowermost trimmer head 58 rotatably supported adjacent a distal end of the handle 56. The trimmer head 58 has a lowermost housing 60 presenting a plurality of line outlet openings 62 spaced around a periphery of the housing 60. The trimmer head 58 further includes an uppermost line cartridge 64 with a supply of trimming line 66 housed therein and an intermediate coupling assembly 68. Trimming lines 66 are fed to the housing 60 from the uppermost line cartridge 64, with an end of each line 66 extending through respective openings 62 to cut grass or other vegetation as the housing 60 is rotated. A conventional guard 70 is also secured to handle 56 near the housing 60.

The trimmer 14 also includes an elongated, axially extending drive shaft 71 with a handle section (not shown) of the drive shaft 71 extending along the length of the handle 56 (see FIG. 3). The drive shaft 71 is coupled at its lower end to assembly 68 via a beveled gear arrangement (not shown) so that powered rotation of the drive shaft 71 rotatably drives the housing 60 for trimming purposes. In the usual manner, the trimmer 14 includes a hand grip 72 and a trimmer switch assembly 74 both mounted on the handle 56 adjacent a proximal end thereof. The hand grip 72 is configured to allow operator manipulation of the trimmer 14. The trimmer switch assembly 74 is configured to be actuated between on and off conditions for controlling clutch engagement as will be discussed further. The trimmer switch assembly 74 includes a lower trigger 76 and an upper depressable button 78. The trimmer 14 is powered by simultaneously depressing the trigger 76 and button 78 so as to restrict inadvertent powering of the trimmer 14. As will be discussed further, the drive shaft 72 further includes a flexible drive shaft section 80 for permitting flexible movement of the trimmer 14.

Turning to FIG. 3, the trimmer 14 further includes a flexible annular sheath 82 and a swivel connector 84. The flexible drive shaft section 80 is operably coupled to the handle section of the drive shaft 71, with the flexible annular sheath 82 covering the drive shaft section 80 and being connected to the handle 56. The swivel connector 84 presents a rotational axis and is attached to a proximal end of the drive shaft section 80 to permit rotational movement of the annular sheath 82 relative thereto. Furthermore, the flexible drive shaft section 90 and the sheath 82 permit flexible movement, i.e., translational and pivotal movement, of the handle 56 relative to the connector 84. In this manner, relative flexible movement is permitted between the trimmer 14 and the coupling assembly 16. Additional preferred details of the trimmer 14 are disclosed in U.S. patent application Ser. No. 11/163,084, filed Oct. 4, 2005, entitled TRIMMER WITH REPLACEABLE LINE CARTRIDGE, which is hereby incorporated by reference herein.

The illustrated trimmer 14 is operable to be used from the seat 18 or from a standing position adjacent to the mower 12. Although the trimmer 14 is preferred for use in the mower 10, it is also within the ambit of the present invention where another powered tool is drivingly coupled to the mower 12 for use in combination with the mower 12.

Turning to FIGS. 1-4, the coupling assembly 16 is designed to drivingly interconnect the proximal end of the flexible drive shaft section 80 remote from handle 56 to the engine 32 of mower 12. To this end, the assembly 16 includes, among other things, a mounting cage 86, an electromagnetic clutch 88, and a safety switch assembly 90. The mounting cage 86 has a central mounting ring 92 and four circumferentially spaced apart legs 94 configured to be attached to the engine 32 by hold-down bolts that secure the cover 54. The ring 92 includes four spaced apart threaded screws 96.

In the usual manner, the clutch 88 includes a clutch housing 98, an input shaft 100 projecting from one end of the housing 98, and an output shaft 102 projecting from an opposite end of the housing 98. The clutch 88 is drivingly connected to the engine 32 by a shaft coupler 104 that releasably receives the input shaft 100 and shaft 52. The housing 98 is fixed relative to the engine 32 by threading screws 96 into the housing 98. The output shaft 102 is drivingly connected to the trimmer 14 by releasably securing the output shaft 102 in an opening presented by the swivel connector 82. The connector 82 permits the trimmer 14 to be rotatably shifted relative to the clutch 88 (see FIG. 3) while maintaining a driving connection between the output shaft 102 and the flexible drive shaft section 80. As will be discussed further, the clutch 88 operably couples the engine 32 and trimmer 14 to selectively power the trimmer 14 in an engaged condition by drivingly connecting the input and output shafts 100,102. In the usual manner, the clutch 88 prevents the engine 32 from powering the trimmer 14 in a disengaged condition by drivingly disconnecting the shafts 100,102. While the illustrated clutch 88 primarily includes structure for either coupling or decoupling the shafts 100,102, it is also within the ambit of the present invention where the clutch 88 includes other structure such as a gear train that serves as a gear reduction between the shafts 100,102.

Turning to FIGS. 3 and 4, the safety switch assembly 90 provides an override function by permitting selective powering of the trimmer 14 unless an unsafe operating condition of the mower 12 is sensed. Specifically, the safety switch assembly 90 preferably includes on and off conditions that operably correspond to respective engaged and disengaged conditions of the clutch 88. The safety switch assembly 90 includes a transmission proximity switch 106 in sensing engagement with the transmission park lever 38, and a PTO proximity switch 108 in sensing engagement with the PTO lever 44. The safety switch assembly 90 further includes a clutch connector 110 operably coupled to the clutch 88 by being inserted into receptacle 112, and electrical cables 114 that electrically interconnect the switches 106,108, the switch assembly 74, and the connector 110.

The transmission proximity switch 106 preferably senses whether the transmission park lever 38 is in the parked position, with the switch 106 correspondingly maintaining the clutch 88 in the disengaged position and preventing the trimmer switch assembly 74 from engaging the clutch 88. In other words, when the safety switch assembly 90 is in the off condition, the assembly 90 serves to override the trimmer switch assembly 74 by preventing the on trimmer switch from engaging the clutch 88 and thereby powering the trimmer 14. In this manner, the operator cannot use the trimmer 14 when the mower 12 is unparked and possibly moving, which serves to limit the possibility of inadvertent operator injury. While the proximity switch 106 is preferred for determining when the mower 12 is in the parked condition, it is equally consistent with the principles of the present invention where another type of sensor is used to sense the parked condition, such as an accelerometer or velocity sensor. While the switch 108 preferably senses whether the mower 12 is parked, it is also within the ambit of the present invention to otherwise sense whether the mower 12 is in a generally non-traveling state, e.g., where the mower 12 is in a neutral condition. In this manner, the safety switch assembly 90 is operable to prevent unsafe trimming when the mower 12 is moving over the ground. Moreover, the transmission sensor could be alternatively positioned relative to the transmission 36 to sense traveling movement. For example, the switch 108 could be positioned adjacent the speed levers 40 to sense if either of the levers 40 is in a neutral position, or a sensor could be positioned adjacent to output shaft 116 of the transmission 36 to sense driving rotation movement of the wheels 24.

In a similar fashion, the PTO proximity switch 108 preferably senses whether the PTO 42 has been engaged to power the mower deck 28. Specifically, the switch 108 is positioned adjacent the PTO lever 44 to determine whether the PTO lever 44 has been shifted to engage the PTO 42. In the instance where the PTO 42 is engaged, the switch 108 causes the safety switch assembly 90 to be in the off condition, which correspondingly disengages the clutch 88 and prevents the trimmer switch assembly 74 from engaging the clutch 88. Again, when the safety switch assembly 90 is in the off condition, the assembly 90 serves to override the trimmer switch assembly 74.

While the switch 108 is preferred for determining when the mower deck 28 is in an operating condition, it is equally consistent with the principles of the present invention where another type of sensor is used to sense operation of the mower deck 28, such as a rotation sensor that senses blade rotation. Although the switch 108 preferably senses the position of the PTO lever 44, it is within the ambit of the present invention to sense activation of the mower deck 28 in other ways, e.g., whether an output shaft 114 of the PTO 42 is rotating. In this manner, the safety switch assembly 90 is operable to prevent an unsafe trimming activity when the mower deck 28 has been activated and the mower blades are rotating. The illustrated safety switch assembly 90 preferably senses traveling movement of the mower 12 and activation of the mower deck 28, but the assembly 90 could sense other operating conditions, particularly to provide a safe operating configuration of the mower 10, without departing from the scope of the present invention.

In the use of mower 10, the operator sits on seat 26 and manipulates the usual rider controls for the mower 12, thereby mowing open areas in the normal fashion. During such operations, the handle 56 of trimmer 14 is seated within the spaced retainers 50, so that the assembly 14 is safely stowed and does not interfere with normal mowing operations (see FIG. 1). Also, in this orientation the clutch 88 is disengaged, i.e., no torque is delivered to flexible drive shaft section 80 or the handle drive shaft section.

When the operator wishes to use the trimmer 14, traveling movement of the mower 12 is stopped and rotating movement of blades in the mower deck 28 is stopped. The handle 56 is then grasped to pull the assembly 14 from the retainers 50, with the grip 72 and trimmer switch assembly 74 being used as handholds for this purpose. The operator then moves the trimmer head 58 to a desired location for trimming and depresses both trigger 76 and button 78. This serves to operate clutch 88 and causes a driving engagement to be established between the engine 32 and trimmer head 58. This in turn rotates housing 60 at high speed to trim the selected area. Preferably, the trimmer switch assembly 74 is wired with the clutch 88 and the mower drive so that the clutch 88 can only be engaged when the mower 12 is stationary. When the selected area is trimmed, the operator releases the trimmer switch assembly 74, causing disengagement of the clutch 88, and replaces handle 56 within the retainers 50.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A multi-purpose lawn care machine configured to mow and trim vegetation, said multi-purpose lawn care machine comprising:
a powered mower that is operable to mow the vegetation and includes a wheeled mower body and an engine that powers a mower wheel to propel the mower body;
a line trimmer that is operable to trim the vegetation and includes a handle, a trimmer head rotatably mounted relative to the handle to cut the vegetation, and a rotatable drive shaft drivingly attached relative to the trimmer head; and
a coupling assembly including an electromagnetic coupler and a safety switch assembly operably connected to the coupler,
said electromagnetic coupler selectively drivingly interconnecting the engine and the drive shaft to power the trimmer,
said electromagnetic coupler being configured to shift between an engaged position to drivingly connect the drive shaft to the engine so that the trimmer is powered by the engine, and a disengaged position to drivingly disconnect the drive shaft from the engine so as to prevent the trimmer from being powered by the engine,
said safety switch assembly including a sensor operably connected to the powered mower to shift the safety switch assembly into and out of an off condition, with the safety switch assembly disengaging the coupler in the off condition,
said sensor being operable to detect a mower operating condition associated with traveling movement of the powered mower,
said sensor causing the safety switch assembly to be retained in the off condition in response to the operating condition to restrict the trimmer from being powered while traveling movement occurs.

2. The multi-purpose lawn care machine as claimed in claim 1,
said powered mower including a transmission that drivingly interconnects the engine and the wheel to transmit power from the engine to the wheel,
said sensor being operably coupled to the transmission to detect the operating condition, wherein the operating condition comprises the transmission transmitting power to the wheel.

3. The multi-purpose lawn care machine as claimed in claim 2,
said transmission including a lever shiftable into and out of a park condition associated with the powered mower being parked,
said park condition being the mower operating condition,
said sensor comprising a proximity switch that detects the park condition by being positioned adjacent the lever in the park condition.

4. The multi-purpose lawn care machine as claimed in claim 1,
said powered mower including a mower deck shiftably mounted relative to the mower body,
said mower deck configured to receive power from the engine during a mowing operation to selectively mow the vegetation, with the safety switch assembly being retained in the off condition during the mowing operation.

5. The multi-purpose lawn care machine as claimed in claim 4,
said safety switch assembly including another sensor, with the another sensor detecting another operating condition associated with the mowing operation of the powered mower to cause the off condition.

6. The multi-purpose lawn care machine as claimed in claim 5,
said engine including a power take-off that drivingly interconnects the engine and the mower deck to transmit power from the engine to the mower deck,
said another sensor being operably coupled to the power take-off to sense the another operating condition, wherein the another operating condition comprises the power take-off transmitting power to the mower deck.

7. The multi-purpose lawn care machine as claimed in claim 6,
said powered mower including a transmission that drivingly interconnects the engine and the wheel to transmit power from the engine to the wheel, with the first-mentioned sensor being operably coupled to the transmission to sense the first-mentioned operating condition and thereby cause the off condition, wherein the first-mentioned operating condition comprises the transmission transmitting power to the wheel.

8. The multi-purpose lawn care machine as claimed in claim 1,
said trimmer including a trimmer switch operably connected to the coupler to selectively engage the coupler and thereby power the trimmer,
said safety switch assembly operably connected to the trimmer switch and configured to override the trimmer switch by preventing the trimmer switch from engaging the coupler when the safety switch assembly is in the off condition.

9. The multi-purpose lawn care machine as claimed in claim 1,
said trimmer including an endmost connector spaced opposite the trimmer head,
said connector drivingly interconnecting the coupler and the drive shaft,
said drive shaft including a flexible drive shaft section drivingly connected to the connector to permit relative flexing movement between the coupler and the trimmer.

10. The multi-purpose lawn care machine as claimed in claim 1,
said trimmer including an endmost connector spaced opposite the trimmer head,
said connector drivingly interconnecting the coupler and the drive shaft,
said connector presenting an upright connector axis and permitting relative swivel movement about the axis between the coupler and the trimmer.

11. A trimmer kit for attachment to a powered mower, wherein the powered mower is operable to mow vegetation and includes a wheeled mower body and an engine that powers a mower wheel to propel the mower body, with the powered mower being shiftable into and out of a park condition associated with the powered mower being parked, said trimmer kit comprising:
a trimmer that is operable to trim the vegetation and includes a handle, a trimmer head rotatably mounted relative to the handle to cut the vegetation, and a rotatable drive shaft drivingly attached relative to the trimmer head; and
a coupling assembly including an electromagnetic coupler and a safety switch assembly operably connected to the coupler,
said electromagnetic coupler operable to selectively drivingly interconnect the engine and the drive shaft to power the trimmer,
said electromagnetic coupler being configured to shift between an engaged position to drivingly connect the drive shaft to the engine so that the trimmer is powered by the engine, and a disengaged position to drivingly disconnect the drive shaft from the engine so as to prevent the trimmer from being powered by the engine,
said safety switch assembly including a sensor configured to be operably connected to the powered mower to shift the safety switch assembly into and out of an off condition, with the safety switch assembly disengaging the coupler in the off condition,
said sensor being operable to detect a mower operating condition associated with traveling movement of the powered mower,
said sensor causing the safety switch assembly to be retained in the off condition in response to the operating condition to restrict the trimmer from being powered while traveling movement occurs.

12. The trimmer kit as claimed in claim 11,
said park condition configured to be the mower operating condition,
said sensor comprising a proximity switch operable to detect the park condition.

13. The trimmer kit as claimed in claim 11,
said safety switch assembly including another sensor, with the another sensor operable to detect another operating condition associated with a mowing operation of the powered mower to cause the off condition.

14. The trimmer kit as claimed in claim 11,
said trimmer including a trimmer switch operably connected to the coupler to selectively engage the coupler and thereby power the trimmer,
said safety switch assembly operably connected to the trimmer switch and configured to override the trimmer switch by preventing the trimmer switch from engaging the coupler when the safety switch assembly is in the off condition.

15. The trimmer kit as claimed in claim 11,
said trimmer including an endmost connector spaced opposite the trimmer head,
said connector drivingly interconnecting the coupler and the drive shaft,
said drive shaft including a flexible drive shaft section drivingly connected to the connector to permit relative flexing movement between the coupler and the trimmer.

16. The trimmer kit as claimed in claim 11,
said trimmer including an endmost connector spaced opposite the trimmer head,
said connector drivingly interconnecting the coupler and the drive shaft,
said connector presenting an upright connector axis and permitting relative swivel movement about the axis between the coupler and the trimmer.

17. A multi-purpose lawn care machine configured to mow and trim vegetation, said multi-purpose lawn care machine comprising:
a powered mower that is operable to mow the vegetation and includes a wheeled mower body and an engine that powers a mower wheel to propel the mower body;
a line trimmer that is operable to trim the vegetation and includes a handle, a trimmer head rotatably mounted relative to the handle to cut the vegetation, and a rotatable drive shaft drivingly attached relative to the trimmer head; and
a coupling assembly including an electromagnetic coupler and a safety switch assembly operably connected to the coupler,
said electromagnetic coupler selectively drivingly interconnecting the engine and the drive shaft to power the trimmer,
said electromagnetic coupler being configured to shift between an engaged position to drivingly connect the drive shaft to the engine so that the trimmer is powered by the engine, and a disengaged position to drivingly disconnect the drive shaft from the engine so as to prevent the trimmer from being powered by the engine,
said safety switch assembly including a sensor operably connected to the powered mower to shift the safety switch assembly into and out of an off condition, with the safety switch assembly disengaging the coupler in the off condition,
said sensor being operable to detect a mower operating condition associated with a mowing operation of the powered mower,
said sensor causing the safety switch assembly to be retained in the off condition in response to the operating condition to restrict the trimmer from being powered while the mowing operation occurs.

18. The multi-purpose lawn care machine as claimed in claim 17,
said powered mower including a mower deck shiftably mounted relative to the mower body,
said mower deck configured to receive power from the engine during the mowing operation to selectively mow the vegetation, with the safety switch assembly being retained in the off condition during the mowing operation.

19. The multi-purpose lawn care machine as claimed in claim 18,
said engine including a power take-off that drivingly interconnects the engine and the mower deck to transmit power from the engine to the mower deck,
said sensor being operably coupled to the power take-off to sense the operating condition, wherein the operating condition comprises the power take-off transmitting power to the mower deck.

20. The multi-purpose lawn care machine as claimed in claim 17,
said trimmer including a trimmer switch operably connected to the coupler to selectively engage the coupler and thereby power the trimmer,
said safety switch assembly operably connected to the trimmer switch and configured to override the trimmer switch by preventing the trimmer switch from engaging the coupler when the safety switch assembly is in the off condition.

21. The multi-purpose lawn care machine as claimed in claim 17,
said trimmer including an endmost connector spaced opposite the trimmer head,
said connector drivingly interconnecting the coupler and the drive shaft,
said drive shaft including a flexible drive shaft section drivingly connected to the connector to permit relative flexing movement between the coupler and the trimmer.

22. The multi-purpose lawn care machine as claimed in claim 17,
said trimmer including an endmost connector spaced opposite the trimmer head,
said connector drivingly interconnecting the coupler and the drive shaft,
said connector presenting an upright connector axis and permitting relative swivel movement about the axis between the coupler and the trimmer.

23. A trimmer kit for attachment to a powered mower, wherein the powered mower is operable to mow vegetation and includes a wheeled mower body and an engine that powers a mower wheel to propel the mower body, said trimmer kit comprising:
a trimmer that is operable to trim the vegetation and includes a handle, a trimmer head rotatably mounted relative to the handle to cut the vegetation, and a rotatable drive shaft drivingly attached relative to the trimmer head; and
a coupling assembly including an electromagnetic coupler and a safety switch assembly operably connected to the coupler,
said electromagnetic coupler operable to selectively drivingly interconnect the engine and the drive shaft to power the trimmer,
said electromagnetic coupler being configured to shift between an engaged position to drivingly connect the drive shaft to the engine so that the trimmer is powered by the engine, and a disengaged position to drivingly disconnect the drive shaft from the engine so as to prevent the trimmer from being powered by the engine,
said safety switch assembly including a sensor configured to be operably connected to the powered mower to shift the safety switch assembly into and out of an off condition, with the safety switch assembly disengaging the coupler in the off condition,
said sensor being operable to detect a mower operating condition associated with a mowing operation of the powered mower,
said sensor causing the safety switch assembly to be retained in the off condition in response to the operating condition to restrict the trimmer from being powered while the mowing operation occurs.

24. The trimmer kit as claimed in claim 23,
said trimmer including a trimmer switch operably connected to the coupler to selectively engage the coupler and thereby power the trimmer,
said safety switch assembly operably connected to the trimmer switch and configured to override the trimmer switch by preventing the trimmer switch from engaging the coupler when the safety switch assembly is in the off condition.

25. The trimmer kit as claimed in claim 23,
said trimmer including an endmost connector spaced opposite the trimmer head,
said connector drivingly interconnecting the coupler and the drive shaft,
said drive shaft including a flexible drive shaft section drivingly connected to the connector to permit relative flexing movement between the coupler and the trimmer,
said connector presenting an upright connector axis and permitting relative swivel movement about the axis between the coupler and the trimmer.
